(19) United States
(12) Patent Application Publication
(10) Pub. No.: US 2014/0303774 A1
(43) Pub. Date: Oct. 9, 2014

(54) VENDING MACHINE COMPRISING CONTAINERS, TO BE LOADED WITH SELECTED PRODUCTS AND THEN SEALED BEFORE DELIVERY

(71) Applicant: BEAVER MACHINE CORPORATION, Newmarket (CA)

(72) Inventors: Bernie Schwarzli, Newmarket (CA); Mark Rendell, Newmarket (CA)

(73) Assignee: BEAVER MACHINE CORPORATION, Newmarket, ON (CA)

(21) Appl. No.: 14/346,162

(22) PCT Filed: Sep. 28, 2012
(86) PCT No.: PCT/CA2012/000902

§ 371 Date: Mar. 20, 2014

(30) Foreign Application Priority Data
Sep. 29, 2011 (CA) 2,753,719

(51) Int. Cl. G07F 11/44

(52) U.S. Cl. CPC G07F 11/44
USPC 700/233

(57) ABSTRACT

An apparatus for vending product comprises a vending machine having a secure housing containing a plurality of vender modules for dispensing a predetermined amount of merchandise into a container. A control panel receives a user selection of product from at least one selected vender module, loads a container onto a shuttle, drives the shuttle into dispensing communication with each selected vender module, and drives each selected vender module through at least one dispensing cycle to dispense the user selection of product. A sealing mechanism seals the container, and a dispensing mechanism dispenses the container to a user-accessible portion of the vending machine. A printer may be provided to print information or indicia, or both, onto the container.

### FIELD OF THE INVENTION

This invention relates to vending machines. In particular, this invention relates to bulk vending machines.

### BACKGROUND OF THE INVENTION

Vending machines are a very popular method of selling merchandise. Bulk venders, for example, in which a metered amount of product stored in bulk in a bin is dispensed upon payment of a required amount of money, can be used for the self-service purchase of myriad types of products. Such vending machines provide a cost-effective means of selling bulk product, in part because they can be located in unsupervised locations and therefore involve very low overhead.

One of the consequences of locating a vending machine in an unsupervised location is that there is no salesperson to attract purchasers or interest prospective customers in the products being vended. The vending machine itself must have a sufficiently interesting and appealing presence to attract purchasers and interest purchasers in the product. Bulk vending machines are nevertheless a popular means of selling small merchandise such as toys and confectionery, part of their popularity being due to the entertainment value associated with the action of a purchaser and the visible reaction of the machine in the dispensing of bulk product. Children in particular are attracted by the visual appeal of bulk product displayed and the product dispensing process. As such, bulk vending machines virtually universally stock product in transparent bins for the visual appeal, and are often manufactured with very large product bins and/or elaborate dispensing paths made deliberately viewable by the purchaser, to increase visual appeal and entertainment value of the vending machine.

For these reasons, while in the past it was common to provide a single bulk vender which stored a single type of product for dispensing to a purchaser, more recently it has become common to locate a cluster or group of bulk venders in one location, sometimes referred to as a bulk vending “island.” This offers purchasers the choice of a variety of bulk product, for example different types of confectioneries, while at the same time increasing the visual appeal of the vending installation and thus increasing the attraction to prospective purchasers.

Systems have been designed for the selective actuation of one or more bulk venders in such a group of bulk venders actuated from a common control station. These systems have been known and used for many decades in self-contained vending machines which vend a variety of types of single articles. For example, in one such type of vending machine a plurality of a particular product item such as a candy bar, package of gum, bag of potato chips etc. is stocked in a coil which, when rotated, advances the product toward a dispensing portion of the machine. A window located at the front of the machine allows a purchaser to watch the dispensing operation. Multiple coils are provided for the vending of different items, each coil supporting a plurality of a particular item. In this type of vending machine a control panel is provided allowing the purchaser, following payment of the required amount, to select a particular article from the variety of articles stocked in the vender by entering an alphanumeric code visually associated with the coil containing the desired product. In response to the purchaser's selection, the coil containing the selected article is actuated through a single rotation, which in an auger-like fashion advances each article seated in the coil toward the front of the machine. By the end of the dispensing cycle the foremost product drops from the coil into a dispensing area accessible to the purchaser.

However, such machines are capable of dispensing only one item, and thus one product type, with each dispensing cycle. Similarly, in a conventional bulk vender island the selection of a product, whether directly or via a shared control panel, actuates only the particular vender containing the selected product and thus dispenses only the single type of product stored in the selected bulk vender. A purchaser may select product from different bulk venders in the island, but must purchase and collect the product from each bulk vender in separate individual transactions.

It would be advantageous to provide to purchasers an opportunity to create a mix of different product types, for example different types of confectioneries, in a single dispensing operation. Such venders would provide a virtually unlimited number of permutations and combinations of bulk mixtures, and allow a purchaser to select specific metered amounts of each product, the various products being dispensed into a single container.

Providing open rigid containers for receiving merchandise in such a multi-vender vending machine can result in dust or other contaminants accumulating in the container prior to a purchase. Also, automatically sealing a rigid container into which bulk product has been dispensed is an involved operation requiring both precision and the ability to accommodate slight deviations between containers, and is thus difficult to effect consistently.

Consumers in modern society are very health conscious, and need a high degree of confidence that the bulk product being dispensed is not contaminated. Consumers also often wish to know the nutritional content of foodstuffs being purchased, and in some regions regulations may require that the nutritional content and/or identification of ingredients of foodstuffs be made available to purchasers on food packages so that the information remains available after purchase of the product.

### BRIEF DESCRIPTION OF THE DRAWINGS

In drawings which illustrate by way of example only embodiments of the invention:

FIG. 1 is a front perspective view of a vending machine according to the invention.

FIG. 2 is a front elevation of the internal components in one embodiment of the vending machine of FIG. 1.

FIG. 3 is a front elevational view of a bulk vender module.

FIG. 4 is a side elevational view of the bulk vender module of FIG. 3 in an operating position.

FIG. 5 is a side elevational view of the bulk vender module of FIG. 3 in a servicing position.

FIG. 6 is a perspective view of a dispensing mechanism in one embodiment of the bulk vender module of FIG. 3.

FIGS. 7 and 8 are side elevational views of a further embodiment of a bulk vender module having a product depletion sensor.

FIG. 9 is a side elevation of the vending machine of FIG. 2 showing a bulk vender module filling a bag with product.

FIG. 10 is a partial side elevation of the bulk vender module showing the dispensing chute in a raised position.

FIG. 11 is a partial side elevation of the bulk vender module showing the dispensing chute in a lowered position for filling a bag with product.

FIG. 12 is a perspective view of the dispensing chute.

FIG. 13 is a plan view of a baffle disposed on the dispensing chute.

FIG. 14 is a perspective view of the baffle of FIG. 13.

FIG. 15 is a perspective view of a further embodiment of a bulk vender module having primary and secondary agitators.

FIG. 16 is a perspective view of an alternate embodiment of a bulk vender module having primary and secondary agitators.

FIG. 17 is a side elevation of the secondary agitator in the bulk vender module of FIG. 16.

FIG. 18 is a perspective view of the dispensing drum showing the operation of a product jam sensor.

FIG. 19 is a perspective view of the dispensing drum showing the optional sensor with a skimmer brush.

FIG. 20 is a partial front perspective view of a first embodiment of the vending machine showing a dispensing system having a bagging system utilizing a bag roll.

FIG. 21 is a front perspective view of the vending machine of FIG. 20 with the shuttle in a home position.

FIG. 22 is a front perspective view of the bagging system of FIG. 20 with the shuttle in a filling position.

FIG. 23 is a front perspective view of a bag tensioning mechanism in the bagging system of FIG. 20.

FIG. 24 is a front perspective view of the bag loading assembly in the bagging system of FIG. 20 showing the bag in a pre-loaded position.

FIG. 25 is a front perspective view of the bag loading assembly in the bagging system of FIG. 20 showing the bag in a partially loaded position.

FIG. 26 is a front perspective view of the bag loading assembly in the bagging system of FIG. 20 showing the bag being detached from the bag roll.

FIG. 27 is a front perspective view of the bag loading system of FIG. 20 with the bag in a fully loaded position.

FIG. 28 is a front perspective view of the bag loading system of FIG. 20 with the bag opened for filling.

FIG. 29 is a front perspective view of the loaded bag in the bagging system of FIG. 20 being filled.

FIG. 30 is a front perspective view of the loaded bag in the bagging system of FIG. 20 being sealed by a sealing assembly.

FIG. 31 is a front perspective view of the sealed bag in the bagging system of FIG. 20 being dispensed.

FIG. 32 is perspective view of a roll of bags for the bagging system of FIG. 20.

FIG. 33 is a front elevational view of a bag reel replacement system for the bagging system of FIG. 20.

FIG. 34 is a front elevational view of the bag reel replacement system of FIG. 38 showing the empty reel lowered out of the operating position and the filled replacement reel engaged in the operating position.

FIGS. 35A to 35C are schematic elevations showing preferred movement of the bag clamps during the bag filling process.

FIG. 36A is a diagrammatic perspective view of information being printed directly onto the wall of a bag.

FIG. 36B is a diagrammatic perspective view of information being printed onto a separate label affixed to the wall of a bag.

FIG. 36C is a diagrammatic perspective view of information being printed onto a label for subsequently affixing to the wall of a bag.

FIG. 37 is a diagrammatic perspective view showing a further embodiment of the bag sealing system utilizing a stack of bags.

FIG. 38 is a diagrammatic perspective view showing a bag returning to the dispensing position in the bagging system of FIG. 37.

FIG. 39 is a diagrammatic perspective view of a bag during the bagging cycle in the bagging system of FIG. 37.

FIG. 40 is a perspective view of a drive mechanism for the bulk vender module of FIG. 15.

FIG. 41A is a perspective view of a clutch in the drive mechanism of FIG. 40 in an engaged position.

FIG. 41B is a perspective view of the clutch FIG. 41A in a disengaged position.

FIG. 42 is a front perspective view of the vending machine showing a combination of bulk vender modules and ribbon vender modules.

### DETAILED DESCRIPTION OF THE INVENTION

The present invention provides a vending machine for dispensing bulk product of different types into a single container, the container in the preferred embodiment being a bag.

According to one embodiment of the invention, a bagging system is provided whereby after a purchaser selects one or more of the plurality of bulk vender modules in the vending machine, a bag is loaded, opened and successively conveyed beneath each selected bulk vender to receive metered amounts of the bulk product selected by the purchaser. After the bag has been filled from each selected bulk vender module, the bag is sealed and dispensed to the user.

Thus, according to the invention the user receives a hermetically sealed container filled with the bulk product selection of the user's choosing, which may comprise one or a plurality of different products such as confectioneries, and sealed to prevent contamination. In a further embodiment of the invention, product identifying information, nutritional information and/or other information or indicia is printed onto the container, or onto a label affixed to the container, after the bag is loaded and prior to the dispensing process.

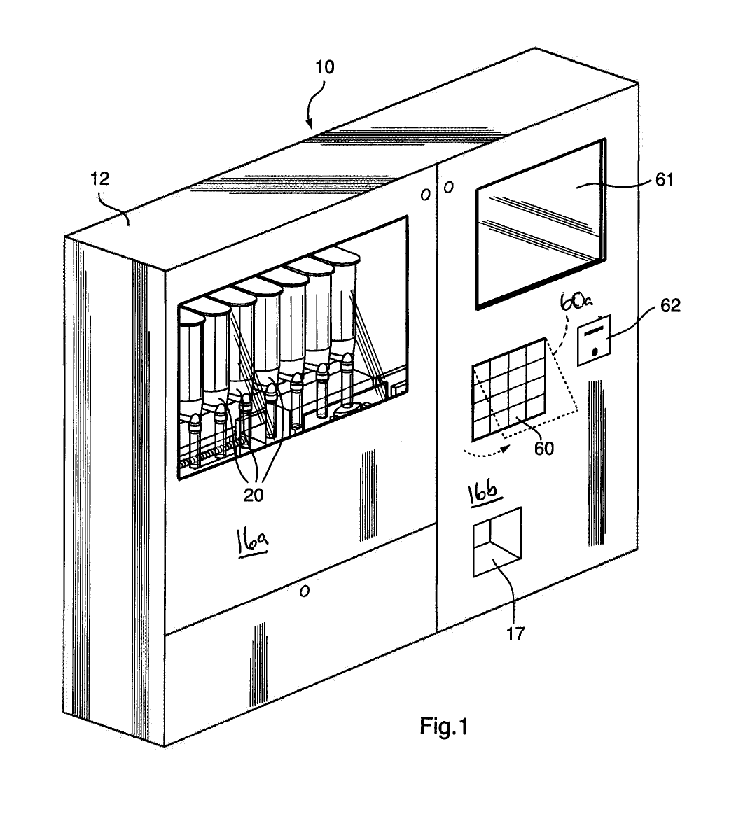

FIG. 1 illustrates by way of example a vending machine 10 according to the invention. The vending machine 10 comprises a secure housing 12, which is preferably provided with at least one door 16a allowing access to the interior of the housing 12, having a transparent glass or plastic window 14 positioned so that a purchaser can observe the dispensing operation. A second door 16b may be provided to facilitate servicing of the vending machine 10.

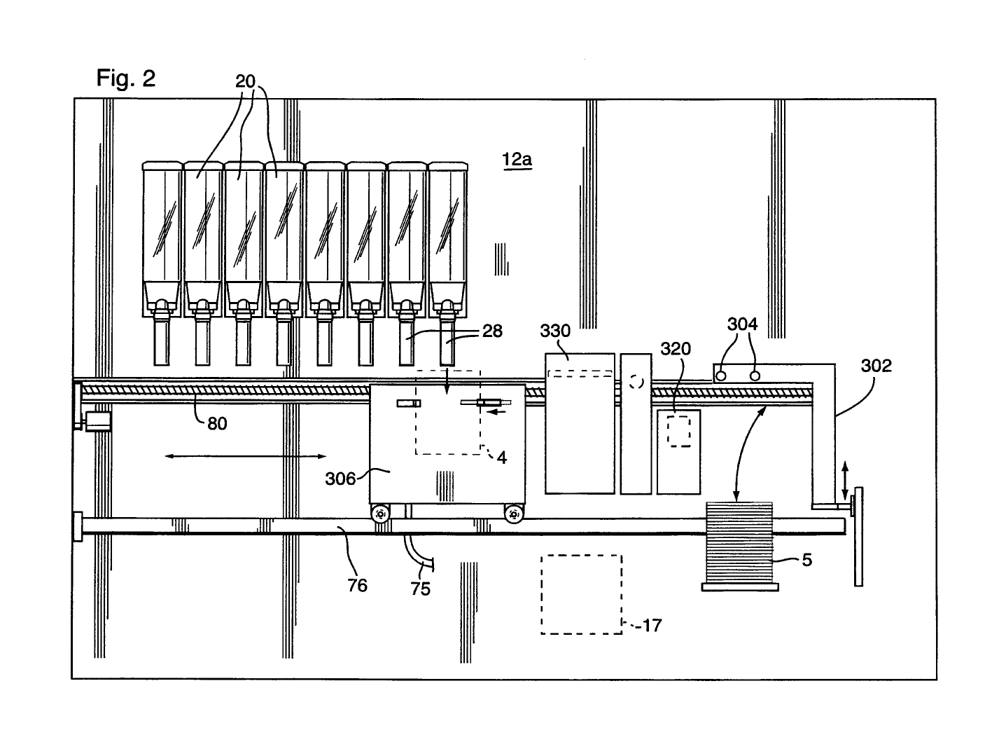

A plurality of vender modules contained within the housing 12 allow for the stocking and vending of different types of product from the vending machine 10. One type of module, for example, is a bulk vender module 20. The bulk vender modules 20 may be disposed in generally horizontal alignment, as illustrated in FIGS. 1 and 2, and visible through the window 14.

In the preferred embodiment a user interface comprises a depressable or touch-sensitive keypad 60 (with an optional protective cover 60a, shown in phantom in FIG. 1) and a video monitor 61 operated by a processor with suitable drivers and/or other software (not shown). In the preferred embodiment the video monitor 61 displays purchase options prompting the user to make one or more selections, and transmits command signals to the processor based on the purchaser's input selection indicating the specific type of product desired to be purchased and the amount of product desired to be purchased from each vender module 20 (which is a multiple of the metered amount held by the dispensing slot 34, described below).

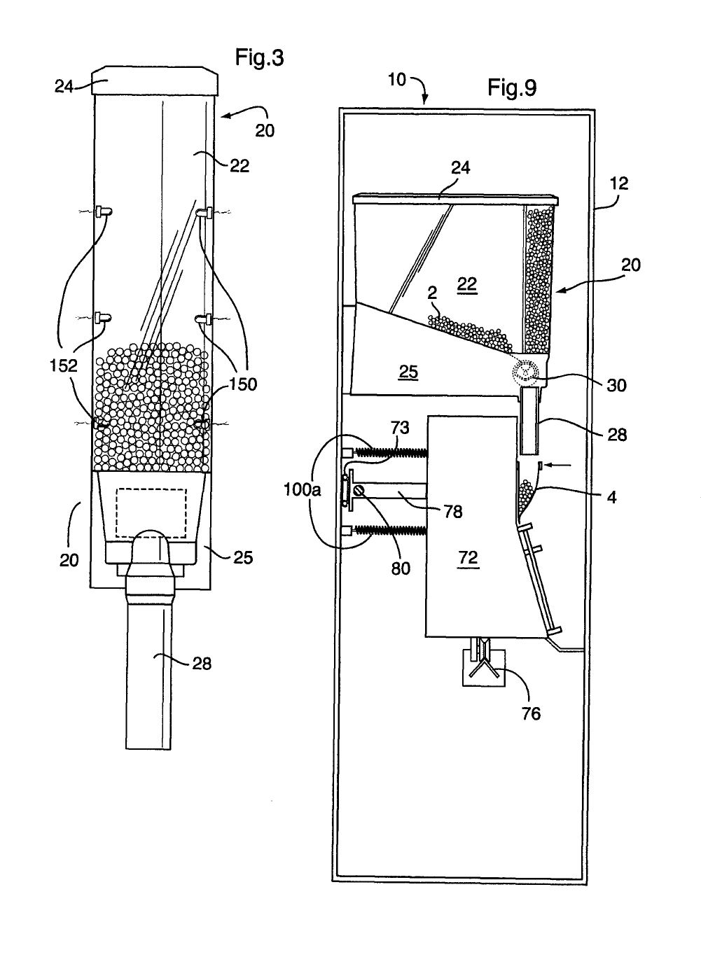

FIGS. 1 and 2 illustrate a plurality of bulk vender modules 20 which are shown in detail in FIGS. 3 to 11. Each bulk vender module 20 comprises a storage section 22 covered by a lid 24, and a dispensing section contained within the base 25 and comprising a dispensing mechanism 30 which dispenses a metered amount of bulk product through a dispensing chute 28.

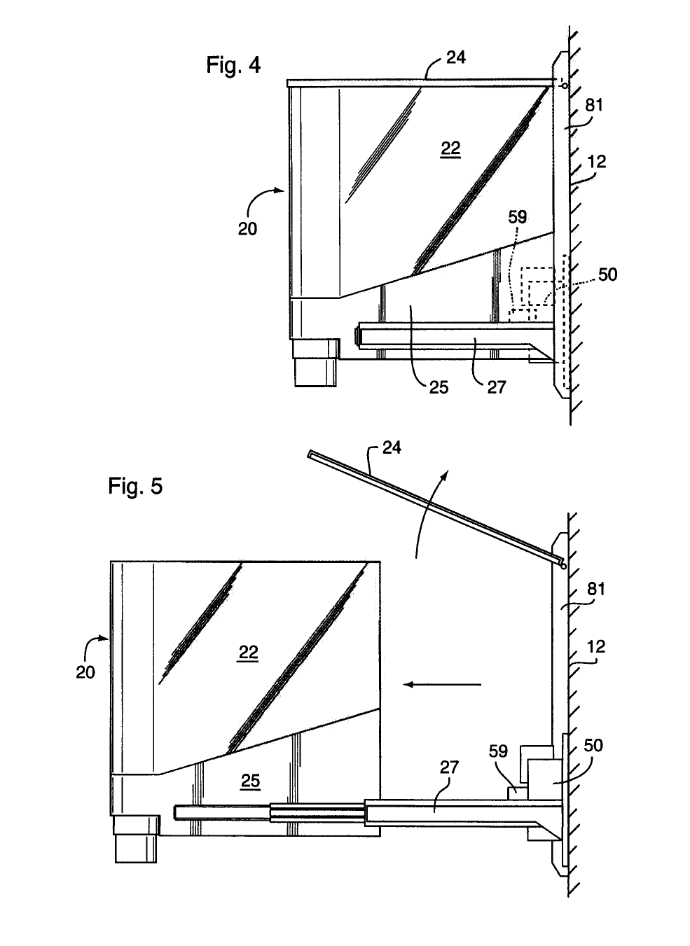

As shown in FIG. 4, each bulk vender module 20 is preferably affixed to and supported by the housing 12, for example mounted to the rear wall 12a of the housing 12. In one embodiment the bulk vender modules 20 may be disposed on extendable members such as conventional drawer tracks 27 (best seen in FIG. 5), allowing each vender module 20 to be independently pulled forward out of the front of the housing 12 for easier servicing and maintenance. In one embodiment a quick-connect electrical connector 59 (shown in FIGS. 4 and 5) containing all electrical connections required for the vender module 20, for example the dispensing motor 50, any separate agitator motor, level sensors etc., decouples from a port (not shown) contained in the base 25 when the vender module 20 is slid out of the housing 12 for service, and recouples to restore the electrical connections when the vender module 20 is slid back into the housing 12 to its operating position.

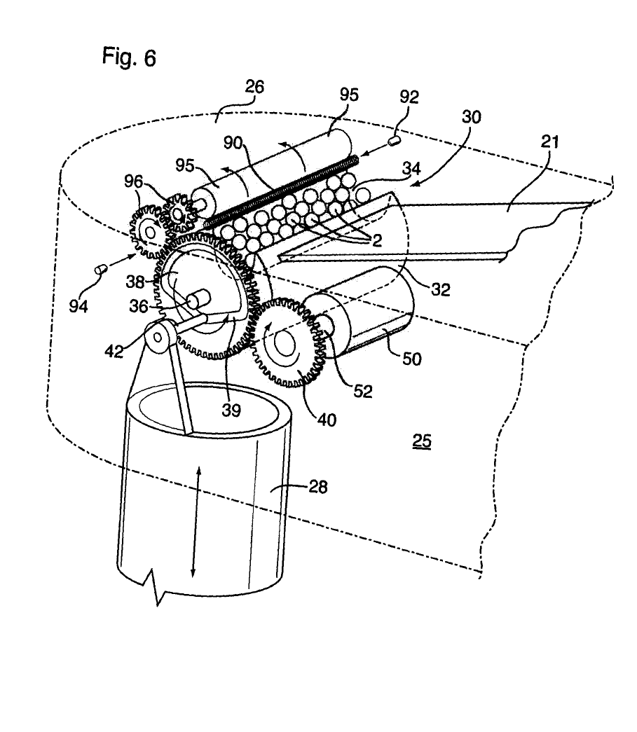

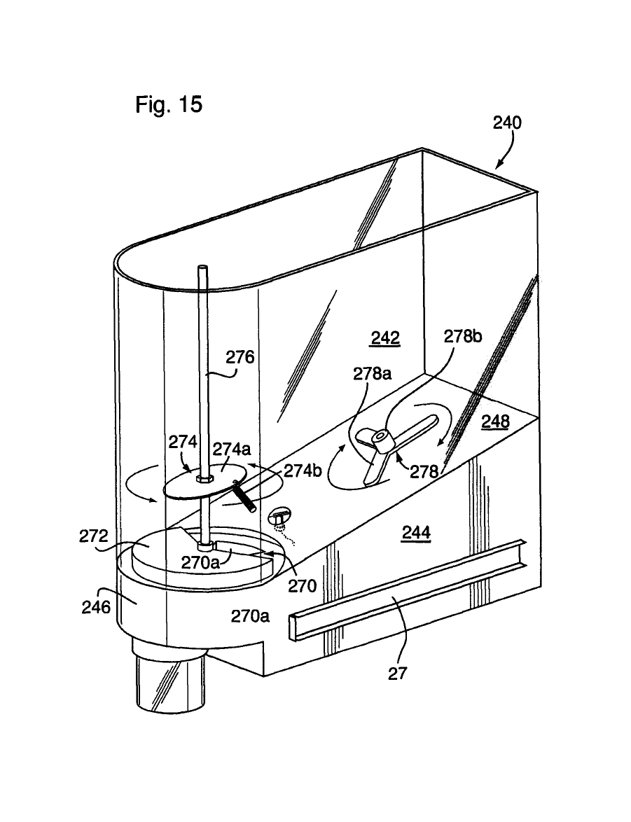

The product bin 22, which is preferably also transparent so that the bulk product 2 stored in the vender 20 is visible to a purchaser through the window 14, is in communication with the dispensing mechanism 30 contained in the dispensing section. As shown in FIG. 6, in the embodiment illustrated the dispensing mechanism 30 comprises a rotating dispensing member, for example a dispensing drum 32. It will be appreciated that although a dispensing drum 34 has been shown by way of example, the dispensing mechanism in any particular vender 20 may alternatively be another type of dispensing mechanism, such as a rotary turntable as illustrated in FIG. 15, or any other suitable dispensing mechanism.

In the embodiment illustrated in FIG. 6 the dispensing drum 32 comprises a dispensing slot 34 for receiving one or more stored product articles, such as confectionery items 2, during a portion of the dispensing cycle when the slot 34 is in communication with articles 2 in the product bin 22. In the preferred embodiment the slot 34 is in communication with articles 2 in the product bin 22 in the rest position of the dispensing drum 32, as shown in FIG. 6. The floor 21 of the product bin 22 is preferably sloped toward the dispensing drum 32, to facilitate filling of the slot 34 when exposed to the bulk product items 2 stored within the product bin 22.

The dispensing drum 32 is mounted on an axle 36 which is in turn rotationally fixed to a drum gear 38. A drive means affixed to the base 25 of the vender 20, for example an electric motor 50 having a drive shaft 52, rotates a drive gear 40 coupled to the drum gear 38 to rotate the drum 32 during the dispensing cycle.

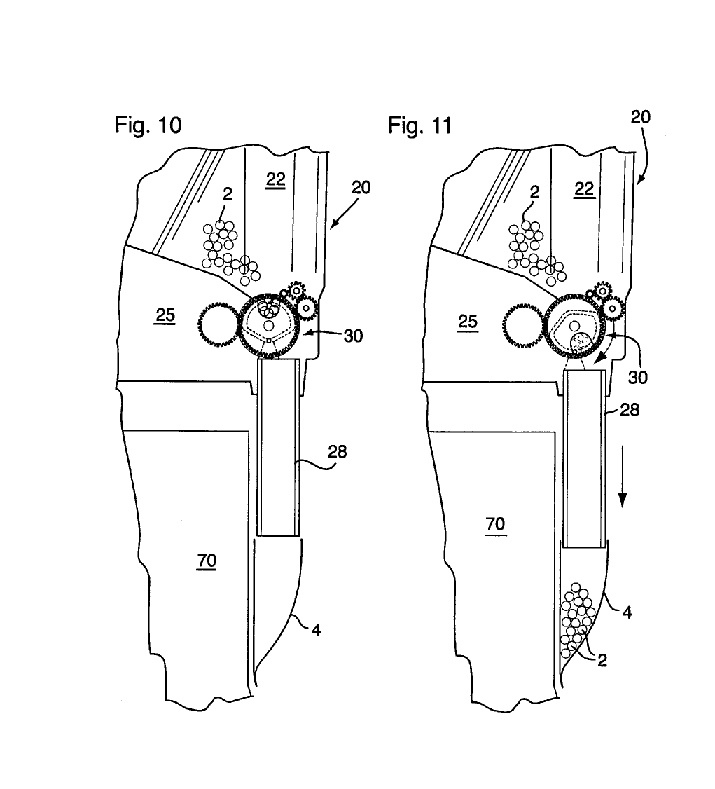

In the embodiment shown, the drum gear 38 comprises an eccentric groove or raceway 39 cut or milled into its face. A stud 42 from which a dispensing chute 28 is suspended is lodged in the raceway 39 and travels along the eccentric path defined by the raceway 39, raising and lowering the dispensing chute 28 as the gear 38 turns. Thus, with each rotation of the drum gear 38 the dispensing chute 28 cycles from a raised position with the lower end of the dispensing chute 28 positioned above the level of the opening of a bag 4, as shown in FIG. 10, and a lowered position with the lower end of the dispensing chute 28 positioned below the level of the opening of a bag 4, as shown in FIG. 11, and thus projecting into the bag 4 which has been loaded onto the bagging mechanism 70 in the manner described below.

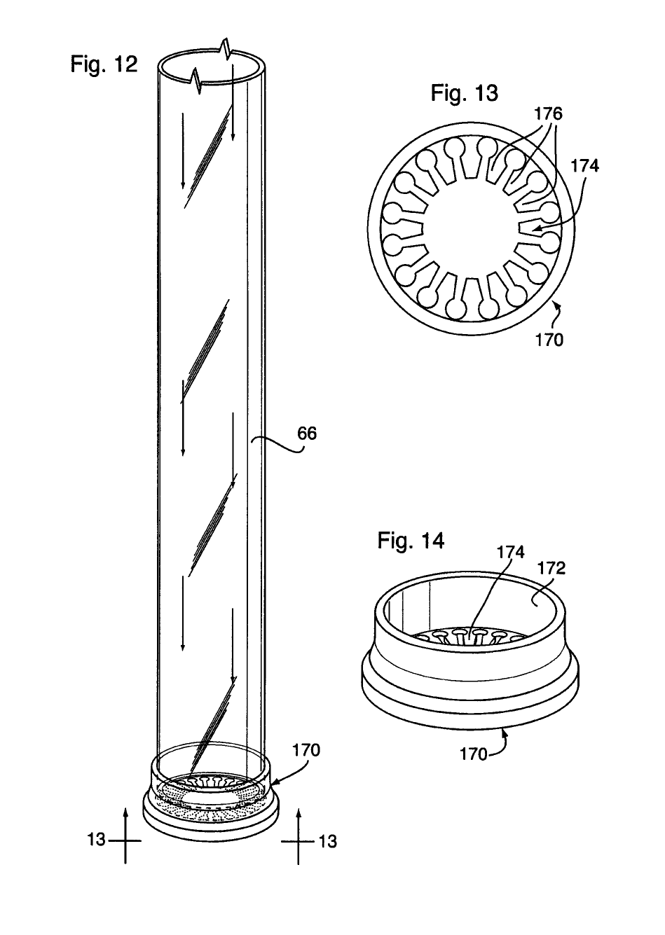

Since product sold in a bulk vender is often breakable, such as candies and other confectionery, in order to avoid breakage of product as it is dispensed from the bulk vending modules 20 through the dispensing chute 28 and into the bag 4, a damper 170 may be provided, as illustrated in FIGS. 12 to 14. In the embodiment shown the damper 170 comprises a collar 172 for friction fit over the lower end of the dispensing chute 28, and a baffle 174 comprising a series of resilient fingers 176 which extend radially toward the center of the dispensing chute 28 and yield under the force of falling product, slowing the descent of the articles 2. The damper 170 may be formed as an integral unit, for example moulded from silicon or any other suitable resilient material, and slip-fitted over the lower end of the dispensing chute 28 in a friction fit.

In one embodiment, illustrated in FIG. 6, an optional sensor is provided to ensure that articles 2 from the product bin 22 are seated properly in the slot 34 before being dispensed. In the embodiment shown a tubular resilient deflectable member, for example a coil spring 90, is disposed above and close to the drum 32. The spring 90 is linear in a rest position. A light source such as a light emitting diode (LED) 92 is disposed in one end of the spring 90, and a light receiver sensitive to the frequency of the light source 92 is disposed in the other end of the spring 90.

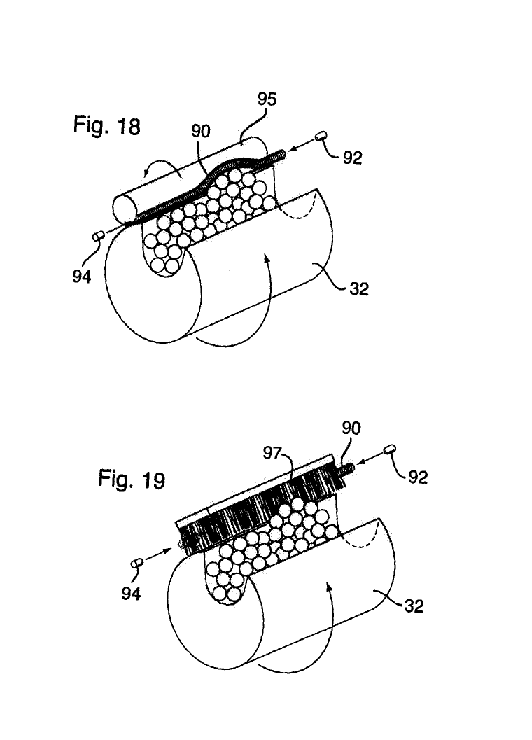

During a dispensing cycle the drum 32 rotates in a forward (dispensing) direction as long as the receiver 94 detects light from the LED 92. If the spring 90 is deflected by articles 2 protruding from the dispensing slot 34 to the point that the spring 90 deflects and breaks the beam of light from the LED 92 to the receiver 94, for example as shown in FIG. 18, the vending machine control software reverses the direction of the drum 34 through a small predetermined arc of rotation, for example 30 degrees, and then resumes driving the drum 32 forward. By virtue of this reciprocating motion, when the forward motion of the drum 32 resumes articles 2 either will have settled into the dispensing slot 34 or will be caught by ejection roller 95, which is driven in the same direction as the drum 32 via gears 96, and ejected back into the product bin 22. This process repeats until no articles are protruding from the slot 34, reducing opportunities for crushing or otherwise deforming articles 2 during the dispensing cycle. The sensor-based reciprocation of the dispensing drum 32 also has the effect of ensuring that articles 2 from the product bin 22 properly settle into the slot 34, so that the intended metered amount of product (as determined by the size of the articles 2 and the volume of the slot 34) is consistently delivered to the purchaser. In an alternate embodiment the ejection roller 95 may be replaced with a brush 97, as shown in FIG. 19.

The specific bulk vender modules 20 from which product will be dispensed to a purchaser, and the amount of product dispensed from the venders 20 with each purchase, are determined by information input into the control panel interface 60 by the purchaser. Each selected vender 20 will be engaged through one or more dispensing cycles, in accordance with the purchaser's selection, and will dispense the purchased product into a single container in the manner described below.

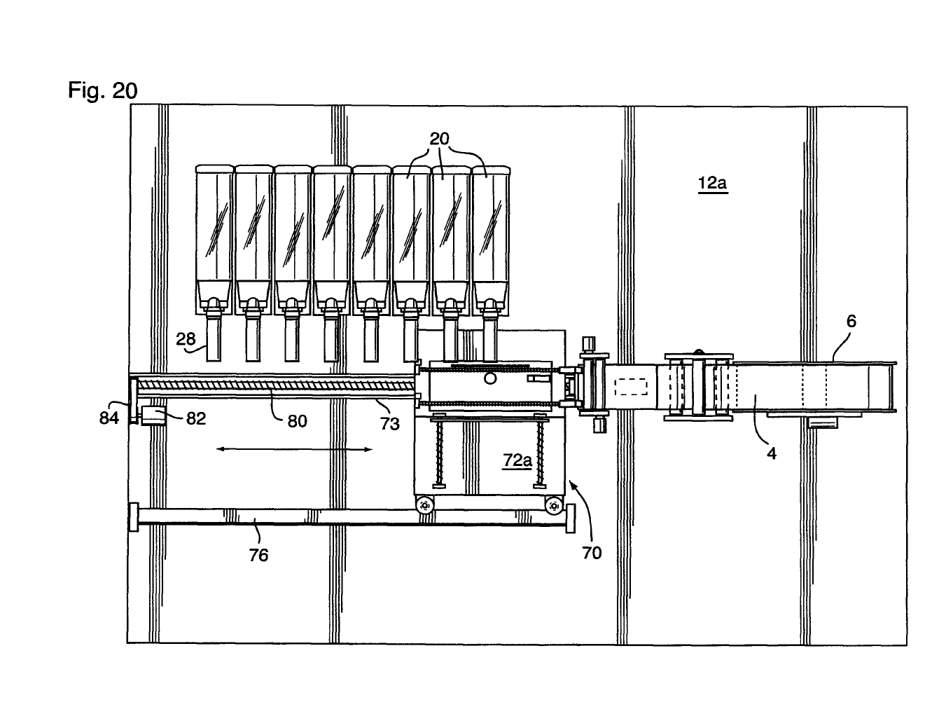

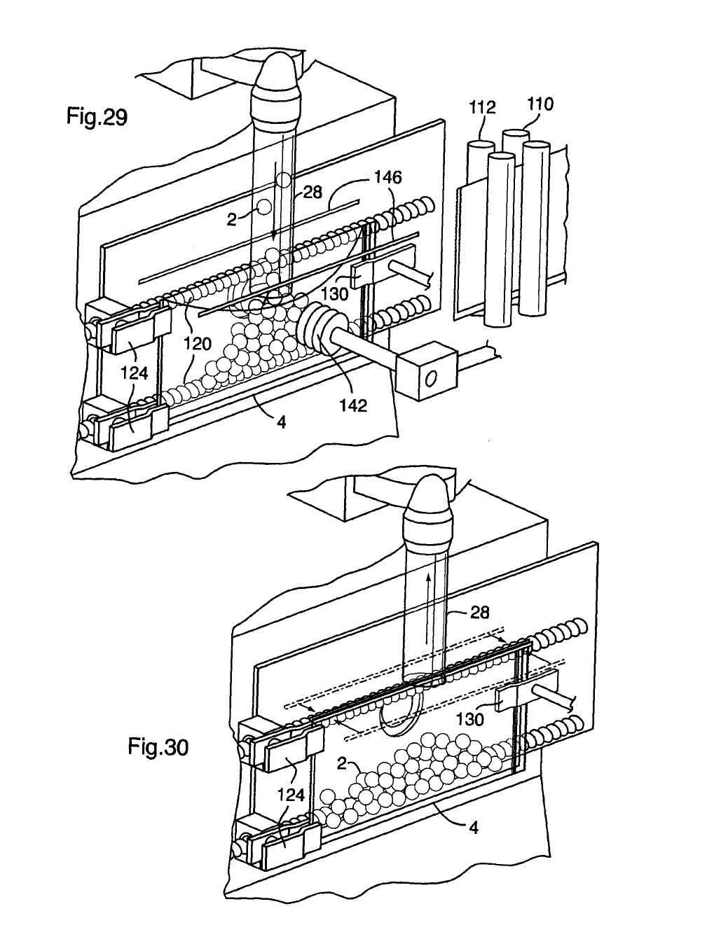

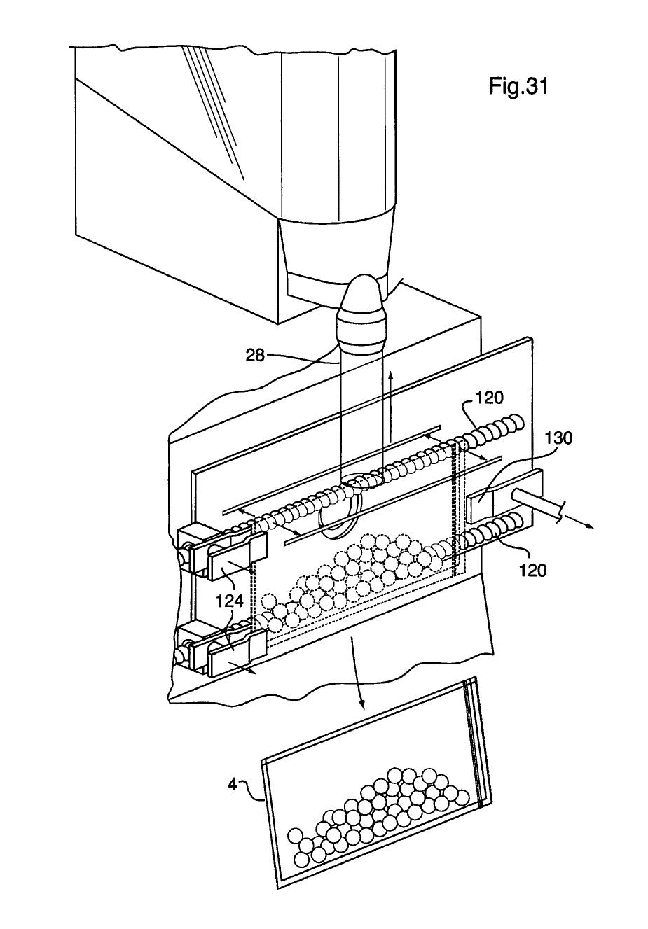

A first embodiment of a bagging system 70 is illustrated in FIGS. 20 to 36. The bagging system comprises a shuttle 72 having rollers 74 supported on a runner bar 76 mounted to the back wall 12a of the housing 12. In the preferred embodiment the runner bar 76 has the profile of an inverted ‘V’, the rollers 74 being provided with a complementary profile as shown to prevent transverse displacement of the rollers 74 and thus maintain the rollers 74 on the runner 76. The shuttle 72 is supported against tilting by a transport member 78 disposed in a track 73 affixed along the back wall 12 of the housing 12 behind the shuttle 70, as shown in FIG. 9.

In the embodiment shown a shuttle transport spindle 80 having a helical thread and driven by a shuttle drive motor 82, via a belt drive 84 or any other suitable drive means, is mounted to the back 12a of the housing 12. The shuttle transport spindle 80 extends through a complementary threaded bore in the transport member 78 projecting rearwardly from the shuttle 72, such that rotation of the spindle 80 in one direction or the other causes the shuttle 72 to move in a corresponding lateral direction beneath the bulk vender bins 20. The transport spindle 80 thus both maintains the upright orientation of the shuttle 72 and drives the shuttle 72 back and forth between the various venders 20, according to a sequence controlled by the vending machine processor (not shown). The shuttle drive motor 82 is thus activated and controlled by the processor to drive the transport spindle 80 in the appropriate direction to a position beneath a selected bulk vender module 20 responsive to control signals issued by the processor, which in turn correspond to purchase requests input by the purchaser into the control panel interface 60. Control signals are transmitted and power is supplied to the shuttle 72 over a flexible cable 75 (shown in FIG. 2), which may for convenience be housed in a rollable segmented cable carrier such as an IGUS™ Easy Chain™ cable carrier from Igus Inc., to avoid impeding the motion of the shuttle 72 and eliminate tangling of the cable 75 when the shuttle 72 is in motion.

The control panel interface 60 is thus connected to the control processor in conventional fashion, such that when the purchaser touches the control panel interface 60 the processor receives signals representing one or more metered amounts of product to be dispensed from one or more of the plurality of bulk vender modules 20. The processor drives the shuttle transport spindle 80 in the appropriate direction and through the number of rotations required to position the shuttle 72 beneath each selected bulk vender module 20, in a sequence determined by the processor software, so that the metered amounts of bulk product will be dispensed from each vender 20 into the bag 4. The processor and associated software (or firmware) for accomplishing this is well known to those skilled in the art.

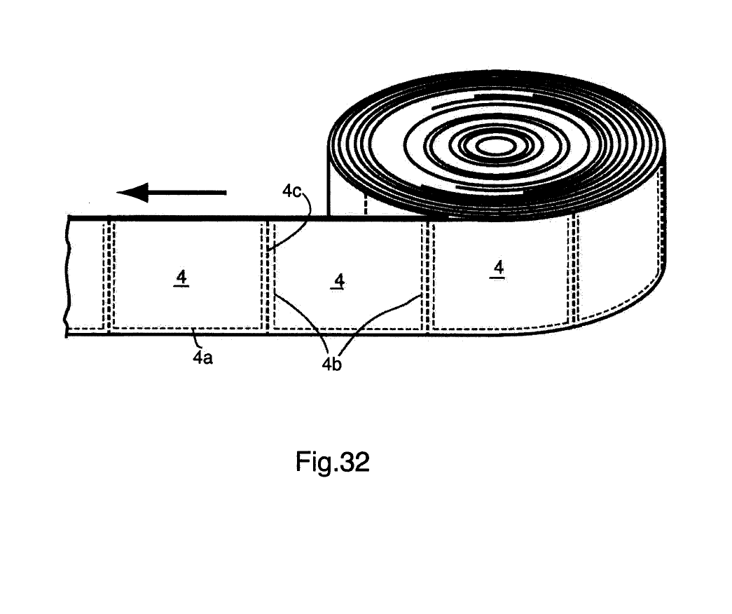

At any suitable time, for example at the beginning of a dispensing sequence, a bag 4 is loaded onto the shuttle 72. The shuttle 72 receives a bag 4 from a bag dispensing system comprising a bag reel 6 carrying a roll of bags 4. Conventionally each bag 4 in the roll comprises a double-walled cellophane (or other plastic) sheet, the sheet being either folded or fused along a bottom seam 4a to form a closed bottom. The roll of bags 4 has transverse seams 4b where the opposed walls of the roll are adhered or fused together to form closed sides of each bag 4, and transverse score lines 4c between adjacent side seams 4b, as best shown in FIG. 32, for separating one of the plurality of bags 4 from the roll as the bag 4 is loaded onto the shuttle 72 in the manner described below. The tops of the bags 4 between seams 4b are detached, thus providing each bag 4 with a top opening.

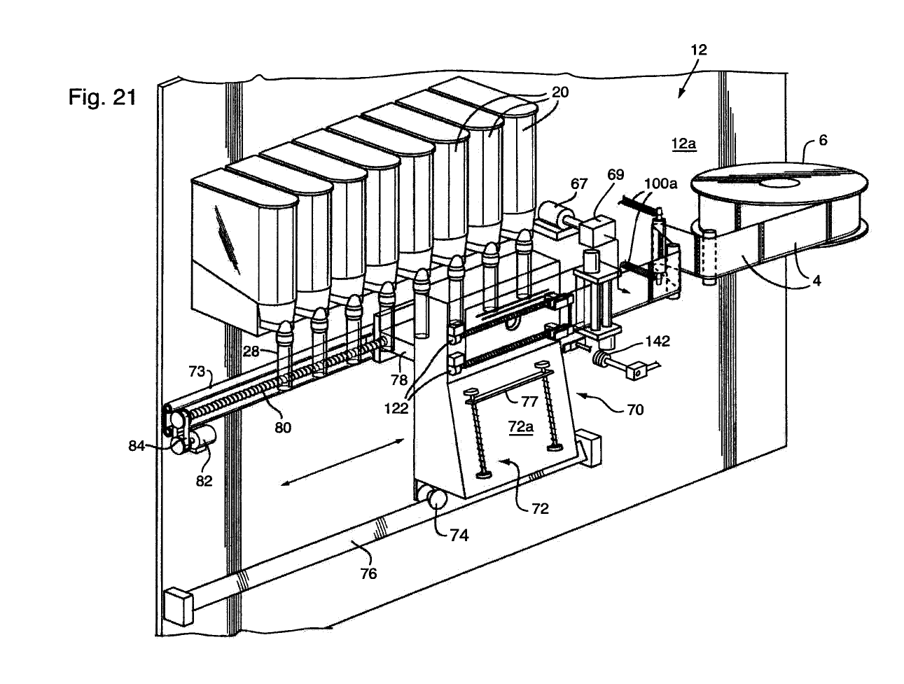

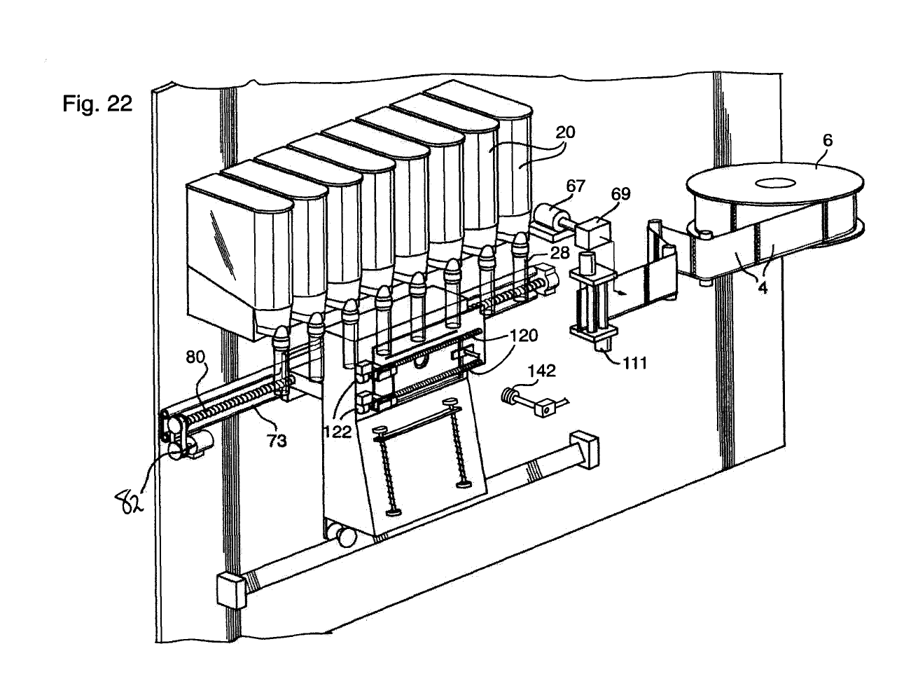

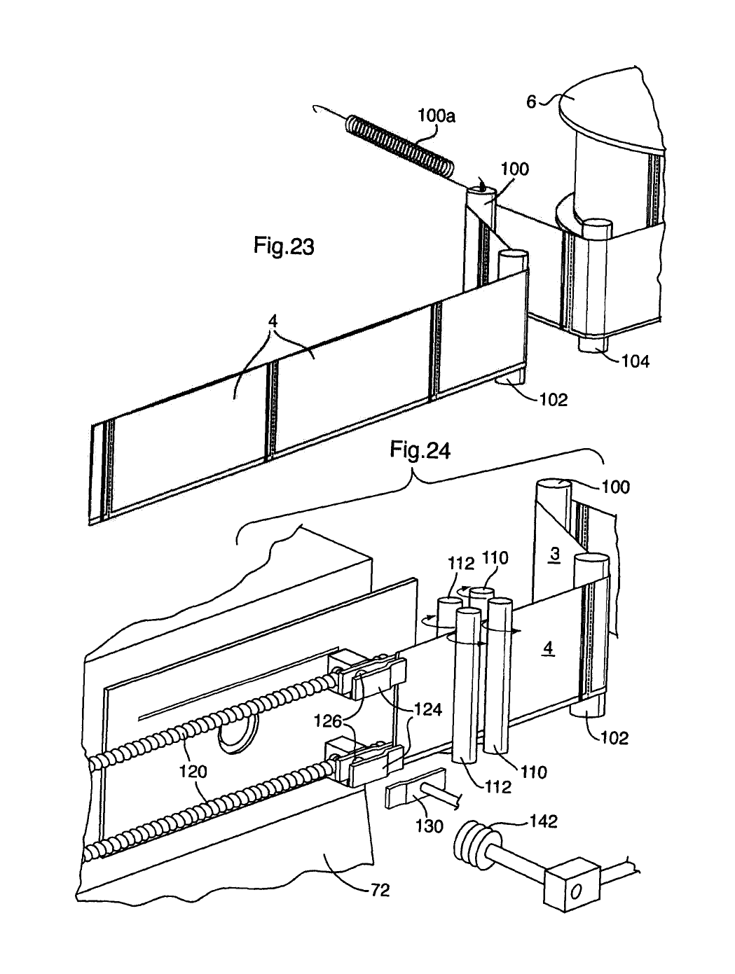

The roll of bags 4 is loaded onto the bag dispensing reel 6, routed around rollers 102, 104 and tensioning roller 100 as shown in FIG. 23, and tensioned for example by tension springs 100a affixed between the rear wall 12a of the housing 12 and a shaft of the tensioning roller 100, as shown in FIG. 21, thus drawing tensioning roller 100 toward the back wall 12a of the housing 12. The roll of bags 4 is then fed through adjacent pairs of pinch rollers 110, 112, best seen in FIG. 24, driven by pinch roller motors 111, 113 as shown in FIG. 22. Motor 111 drives upstream pinch rollers 110 in opposite directions, and motor 112 drives downstream pinch rollers 112 in opposite directions, such that pinch rollers 110 and pinch rollers 112 are independently controllable. Tension is maintained between the reel 6 and the pinch rollers 110, 112 by tensioning roller 100.

The bag 4 at the free end of the roll is loaded onto the shuttle 72. The shuttle 72 comprises a front face 72a supporting upper and lower clamp transport spindles 120, each rotatably anchored to the shuttle 72 at a downstream end and driven by clamp transport spindle motors 122. The clamp transport spindles 120 each have a helical thread and respectively extend through complementary threaded bores in upper and lower bag loading clamps 124. The bag loading clamps 124 are actuated between clamping and open positions by an actuator such as a solenoid or piston 126, preferably biased to the open position, and are driven laterally across the face 72a of the shuttle 72 by rotation of the clamp transport spindles 120 via servo motors 122 (best seen in FIG. 22).

The bag loading clamps 124 thus clamp onto the leading (downstream) side edge 4b of a bag 4 to draw the bag 4 onto the face 72a of the shuttle 72, preferably clamping over upper and lower portions of the leading side edge of the bag 4, as shown in FIG. 24. Once the bag loading clamps 124 have secured the bag 4, the pinch rollers 110, 112 rotate in the forward (loading) direction and the bag 4 is loaded onto the face 72a of the shuttle 72 by rotation of the clamp transport spindles 120, which draw the bag loading clamps 124 toward the downstream end of the shuttle 72, as shown in FIG. 26.

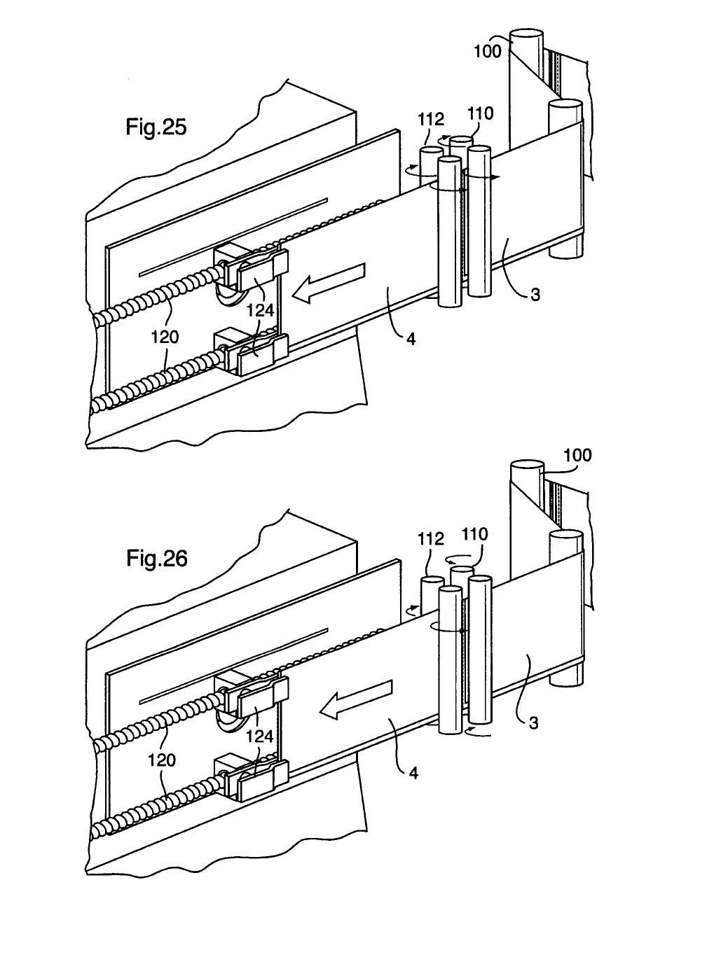

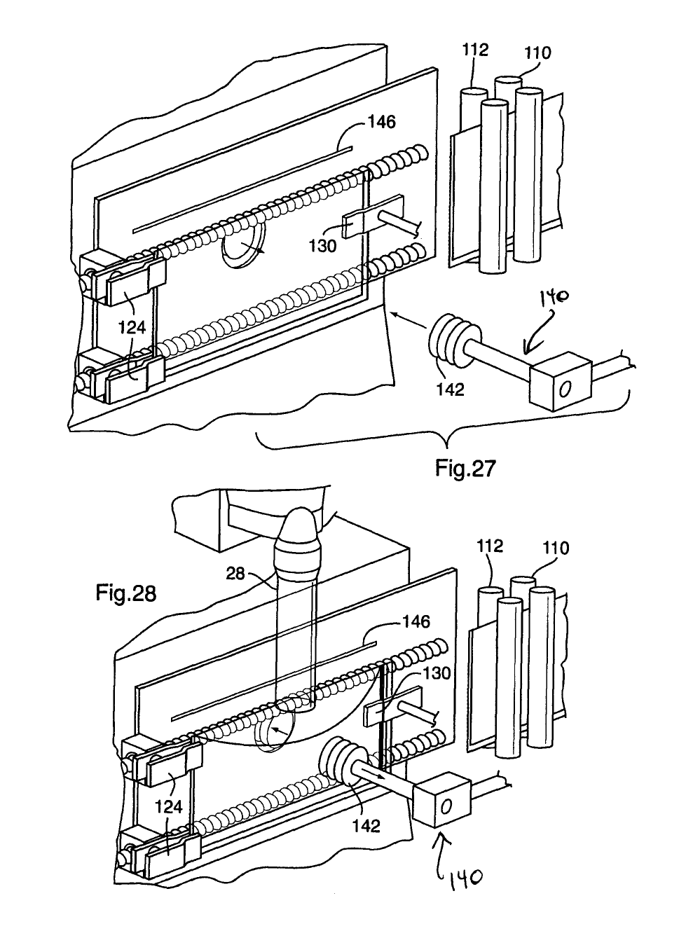

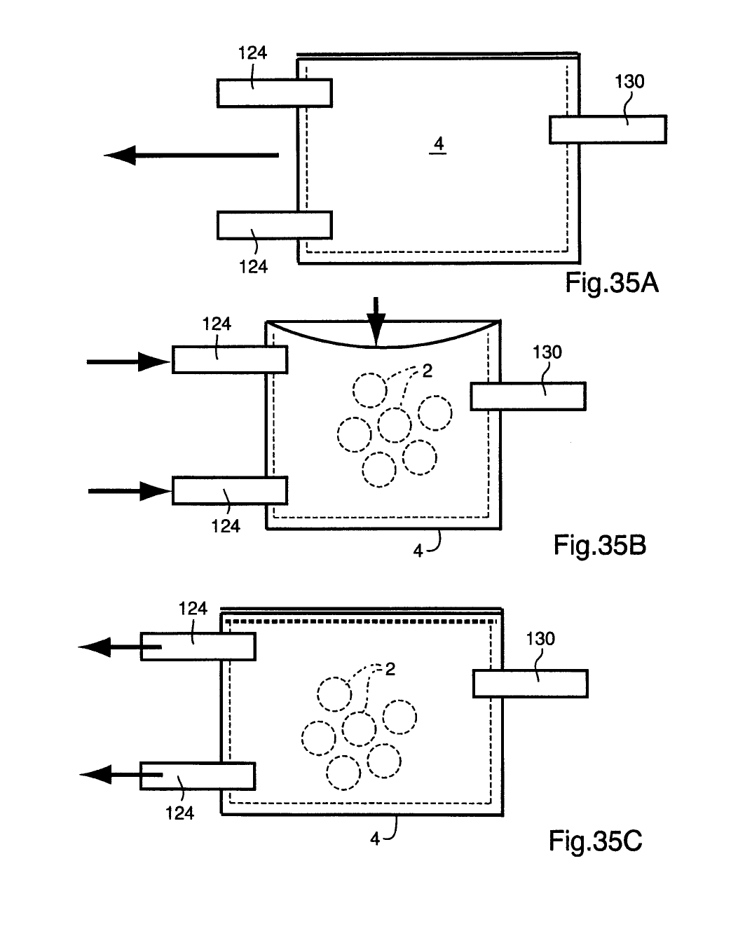

At the position where the score line 4c between the bag 4 being loaded and the next upstream bag 3 in the roll reaches the space between the pairs of pinch rollers 110, 112, as shown in FIG. 25, rotation of the upstream pinch rollers 110 is arrested, as shown in FIG. 26. Continued rotation of the downstream pinch rollers 112 detaches the bag 4 being loaded from the next upstream bag 3 in the roll, along the score line 4c therebetween. The bag loading clamps 124 continue to draw the bag 4 onto the face 72a of the shuttle 72 until the bag loading clamps 124 reach the downstream end of the face 72a of the shuttle 72, as shown in FIGS. 27 and 35A.

Once the bag loading clamps 124 have reached the downstream end of the face 72a of the shuttle 72, a bag retaining clamp 130 is actuated by an actuator such as a solenoid or piston (not shown) to retain the trailing (upstream) side edge 4b of the bag 4 in position against the face 72a of the shuttle 72, as shown in FIG. 27.

An actuator such as a solenoid or piston (not shown) then moves bag opening device 140 toward the bag 4 until the suction cup 142 contacts the front panel of the bag 4. The suction cup 142 grabs the front panel of the bag 4, and the suction device 140 is then retracted to open the bag, as shown in FIG. 28. The bag opening process may optionally be assisted by an air burst from an air pulse device (not shown) disposed above the bag 4. The bag opening process may also or alternatively be assisted by moving the bag loading clamps 124 slightly upstream, as shown in FIG. 35B, reducing the tension on the bag 4 and allowing the front panel of the bag 4 to more readily droop toward an open position for filling. In this embodiment, after filling the bag loading clamps 124 are returned the downstream end of the face 72a of the shuttle 72 to stretch the bag 4 for sealing.

In the operation of this embodiment, the product storage bins 22 of bulk vender modules 20 are filled by service personal, by opening the door 16a of the housing 12, opening the lid 24 of each product bin 22, pouring the desired product (for example one of a variety of different types of confectionery) into each respective product bin 22, and closing the lid 24. The service person also ensures that a sufficient supply of bags 4 is disposed on the reel 6, and that the free end of the roll of bags 4 is properly fed through fixed rollers 102, 104, the tensioning roller 100 and pinch rollers 110, 112 so that the leading side edge 4b of the bag 4 at the free end of the roll protrudes sufficiently to be reached by the bag loading clamps 124. If the type of product is being changed from a product previously stored in a particular vender 20, a label on the vender 20 may be changed to identify the new product, and/or the product identification may be recorded in the processor to be displayed on the control panel interface 60. The service person closes and locks the door 16 of the housing 12.

A purchaser who desires to purchase product selects the bulk vender module 20 (for example by number, product name, image or otherwise), as prompted by the display of the control panel interface 60, by touching the appropriate region of the control panel interface 60. The purchaser can select the same bulk vender module 20 multiple times to purchase a plurality of metered dispensing amounts of the same type of product, and/or other bulk vender modules 20 containing other products sought to be purchased as part of the product mix. When the purchaser is finished selecting (indicated for example by the purchaser touching a particular region of the control panel interface 60 displaying an ‘OK’ key or another end-of-sequence indicator), the control panel interface 60 displays the amount of money required to pay for the selected product. The user inserts the required amount of coinage into a coin slot 63a, or a bill of a sufficient denomination into the bill accepter slot 63b, or a card such as a credit card, debit card or gift card into the card reader slot 62, in order to make payment. When the correct amount of money for the selected amount of bulk product has been inserted (or the credit card or debit card payment has been made via card acceptor 62 and authorized), the vending machine dispensing cycle is initiated.

In the preferred embodiment, during the dispensing cycle the processor generates a vending sequence which loads a bag 4 into the shuttle 2, prints product identifying and/or nutritional information and/or other information or indicia onto the bag 4 (or onto a separate label), opens the bag 4, and then moves the shuttle 72 to a position beneath each selected vender 20 in the processor-generated sequence, and at the end of the dispensing sequence returns the shuttle 72 to the home position shown in FIGS. 20 and 21.

To load the bag 4 onto the shuttle 72, the upstream and downstream pinch rollers 110, 112 are actuated to move the bag 4 downstream until the leading side edge 4b of the bag 4 is disposed between the respective jaws of the bag loading clamps 124, which are preferably biased to the open position. The bag loading clamps 124 are then actuated to the clamping position by actuators 126, to clamp the leading side edge 4b of the bag 4. Clamp transport motors 122 are actuated to draw the bag 4 laterally across the face 72a of the shuttle 72 by rotation of the clamp transport spindles 120 within the threaded bores extending through the bag loading clamps 124, while the pinch rollers 110, 112 rotate in the forward (loading) direction, paying off the roll of bags as the leading bag 4 is being loaded.

When the score line 4c between the bag 4 being loaded and the next upstream bag 3 in the roll passes the upstream pinch rollers 110, as shown in FIG. 25, rotation of the upstream pinch rollers 110 is arrested, as shown in FIG. 26. Continued forward rotation of the downstream pinch rollers 112 detaches the bag 4 being loaded from the next upstream bag 3 in the roll along the score line 4c. When the bag 4 being loaded has cleared the pinch rollers 12, rotation of the pinch rollers 112 is arrested. The bag loading clamps 124 continue to draw the bag 4 onto the face 72a of the shuttle 72 until the bag loading clamps 124 reach the downstream end of the face 72a of the shuttle 72.

Once the bag 4 is fully extended across the front face 72a of the shuttle 72, the upstream bag retaining clamp 130 is actuated and depresses the trailing (upstream) side edge 4b of the bag 4 against the face 72a of the shuttle 72, to retain the bag 4 in position during printing and filling, as shown in FIG. 27. In the preferred embodiment the processor actuates solenoid 67 and enables the print head 69 (shown in FIG. 21) to print the selected product names (and optionally nutritional and/or other information or indicia) onto the front panel of the loaded bag 4.

When the printing operation is complete, the bag opening device 140 is moved to the bag opening position, with the suction cup 142 contacting the front panel of the bag 4. The suction cup 142 grabs the front panel of the bag 4 and the suction device 140 is retracted to open the bag, as shown in FIG. 28. If desired the bag loading clamps 124 may be moved slightly upstream as the bag opening device 140 is retracted, as shown in FIG. 35B, reducing the tension on the bag 4 and allowing the front panel of the bag 4 to droop forwardly. The loaded bag 4 is then ready to be filled. It will be appreciated that although a suction cup 142 is shown, the bag opening device 140 may instead have air assisted-suction, or alternatively may utilize a releasable adhesive tip or the like to releasably adhere to the front panel of the bag 4.

Once the loaded bag 4 is opened, the processor begins to drive the shuttle 72 in sequence to a position beneath (i.e. in substantially vertical alignment with) each selected bulk vender module 20. The processor drives shuttle drive motor 82, which rotates the shuttle transport spindle 80 as necessary to position the shuttle beneath the first of the bulk vender modules 20 in the vending sequence. Once the shuttle 72 reaches this position, the processor initiates a dispensing cycle of the bulk vender module 20 disposed above the shuttle 72 (and thus above the opening of the bag 4).

The processor starts dispensing drive motor 50 to rotate the driveshaft 52 through the required number of rotations to dispense the selected amount of bulk product from the bin 20. For example, the drum gear 38, and thus the drum 32, rotates through one full rotation with each dispensing cycle. With each dispensing cycle, the predetermined metered amount of bulk product in the product bin 22 is captured in the dispensing slot 34 as shown in FIG. 10 and, as the drum 32 continues to rotate, dispensed through the dispensing chute 28 as shown in FIG. 11.

As the drum 32 moves from the home position shown in FIG. 10 toward the dispensing position, the eccentric stud 42 moves to the bottom of its orbital rotation about the shaft 36, lowering the dispensing chute 28 into the bag 4 as shown in FIG. 11 to prevent spillage of product. Similarly, as the drum 32 moves from the dispensing position shown in FIG. 11 toward the home position, the eccentric stud 42 moves along the raceway 39 to the top of its eccentric orbit and thus raises the dispensing chute 28 out of the bag 4, as shown in FIG. 10, providing a clearance for the shuttle 72 to move to the next vender 20 in the vending sequence.

The drum 32 returns to the home position, in the embodiment illustrated with the dispensing slot 34 in communication with the product in the product bin 22, to end the dispensing cycle for that particular vender 20.

When the processor determines that the first vender 20 in the vending sequence has completed its dispensing cycle, which may be accomplished in any suitable fashion including, without limitation, by monitoring the rotational progress of the dispensing mechanism or receiving a pulse from a limit switch (not shown), the processor moves the shuttle 72 to a position beneath the next bulk vender module 20 in the vending sequence, and the filling process is repeated. For each selected product, once the shuttle 72 is correctly positioned beneath the respective bulk vender module 20 containing that product, the dispensing drive motor 50 associated with that bulk vender module 20 rotates through the required number of rotations to dispense the purchased amount of bulk product into the opening of the bag 4.

The shuttle 72 may be positioned beneath each selected bulk vender module 20 in sequence (i.e. moving in a single direction), or may move back and forth between venders 20 in the order selected by the user or in a random order to increase the “entertainment” provided by the vending sequence (particularly to children). The processor monitors the current position of the shuttle 72, and the transport spindle drive motor 82 rotates the transport spindle 80 through the required number of turns in the required direction in order to reposition the shuttle 72 beneath the next bulk vender module 20 in the sequence. A spring-loaded support bar 77 may be provided on the face 72a of the shuttle 72, to assist in supporting the bag 4 as it is being filled.

Once all bulk vender modules 20 have dispensed their respective product as selected by the purchaser into the loaded bag 4, completing the vending sequence, the shuttle 72 returns to its home position and the bag 4 is closed, for example by pressure applied by opposed closing rails 146 against a ‘zipper’ closure integrated into the top of the bag 4, and thus hermetically seal the bag 4 for dispensing to the purchaser, as shown in FIG. 30, through an opening 17 in the door 16a of the housing 12. Alternatively, a fuser may be applied to thermally fuse the bag walls along the top or releasable adhesive or other means may be used to seal the top of the bag 4.

Once the filled bag 4 has been sealed, the shuttle 72 returns to the home position shown in FIG. 21. The filled bag 4 is dispensed by releasing the bag loading clamps 124, allowing the bag to drop off of the shuttle 72 into the purchaser-accessible dispensing opening 17.

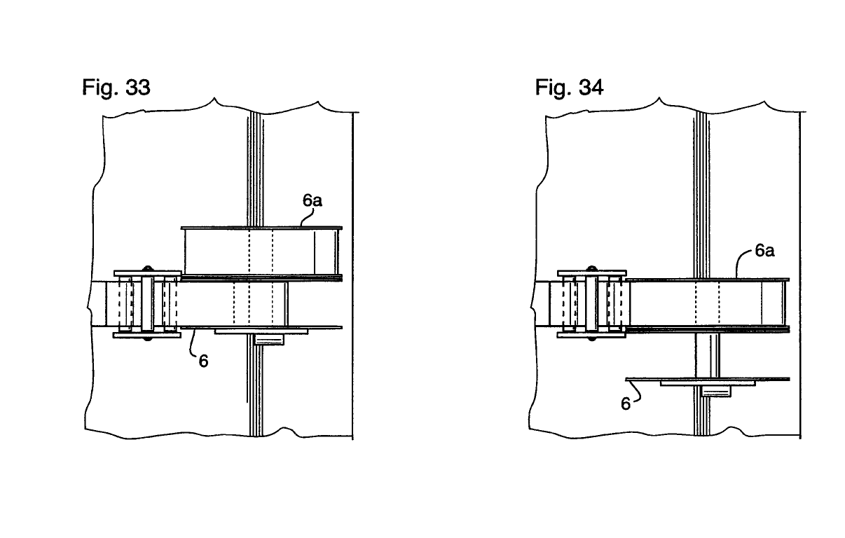

In one embodiment, shown in FIGS. 33 and 34, a replacement bag reel 6a is mounted adjacent to the bag reel 6 and can be dropped into position when the bag reel 6 is depleted.

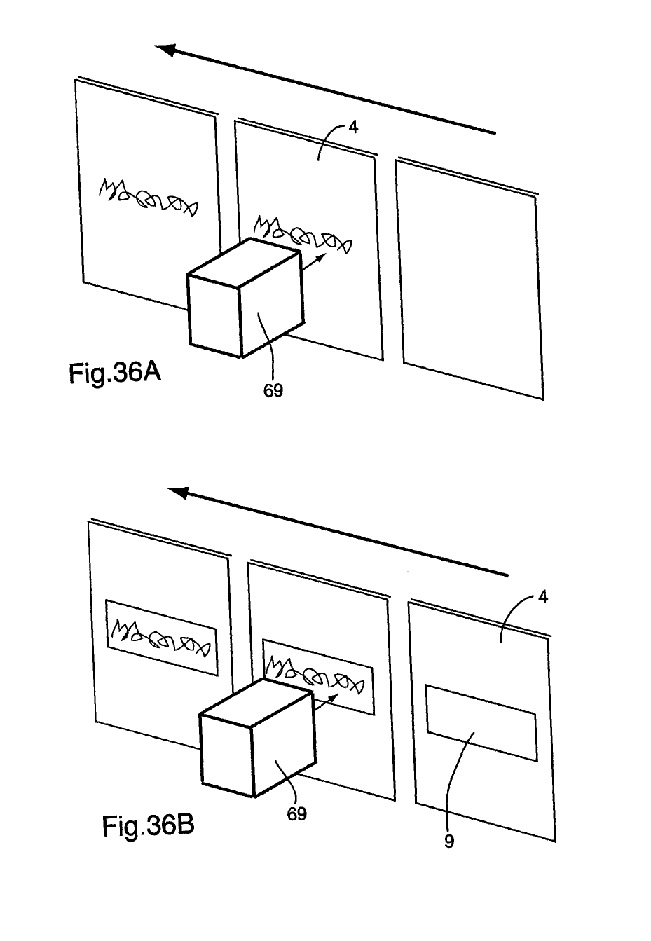

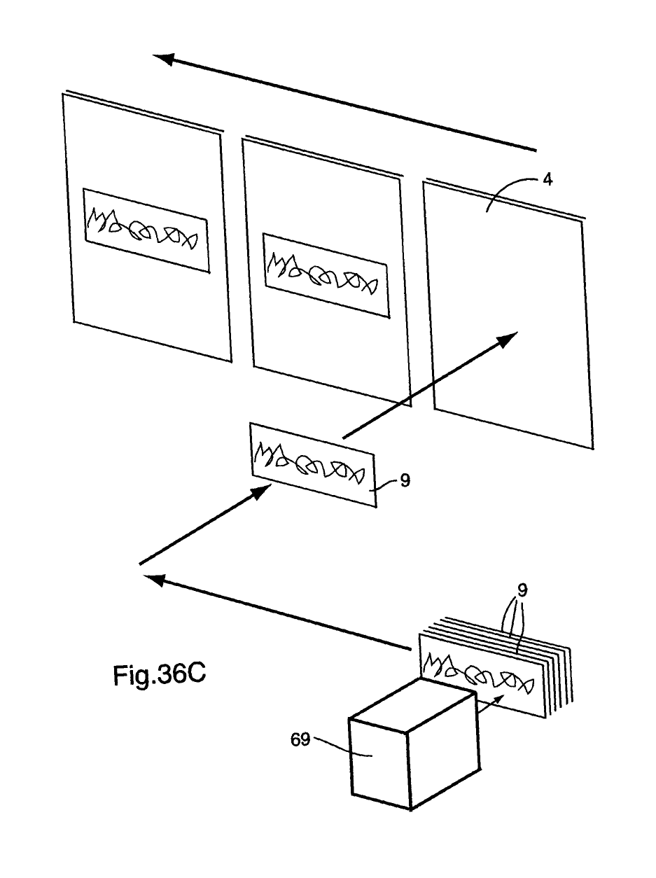

As the user enters selections into the control panel interface 60, the selections correspond to indicia stored in the processor memory. The processor comprises a print driver, which tasks the print head 69 to print indicia corresponding to each selection made by the user onto the bag as shown in FIG. 36A (or onto a separate label 9 as shown in FIGS. 36B and 36C). The indicia may merely identify the selected product, or may include additional information about the product including for example (without limitation) nutritional information.

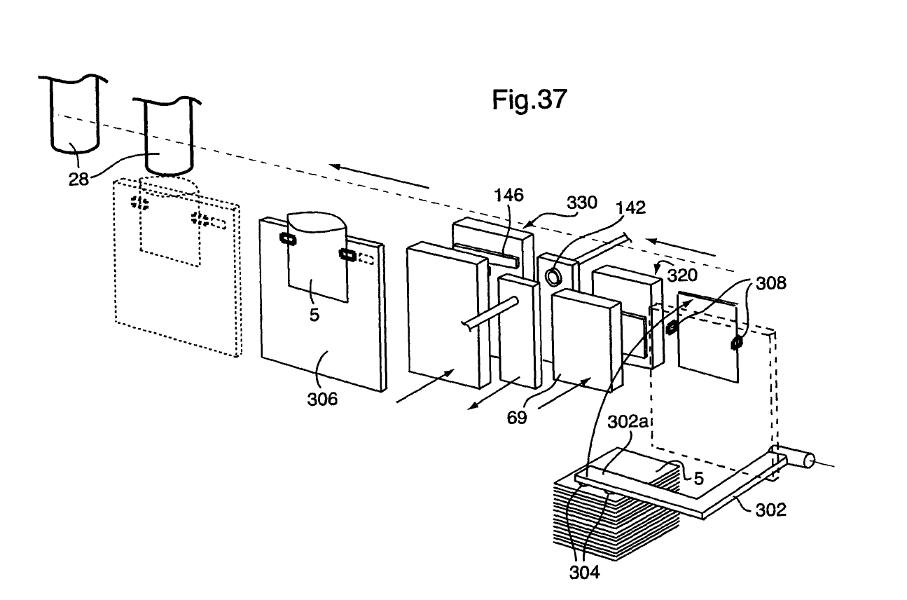

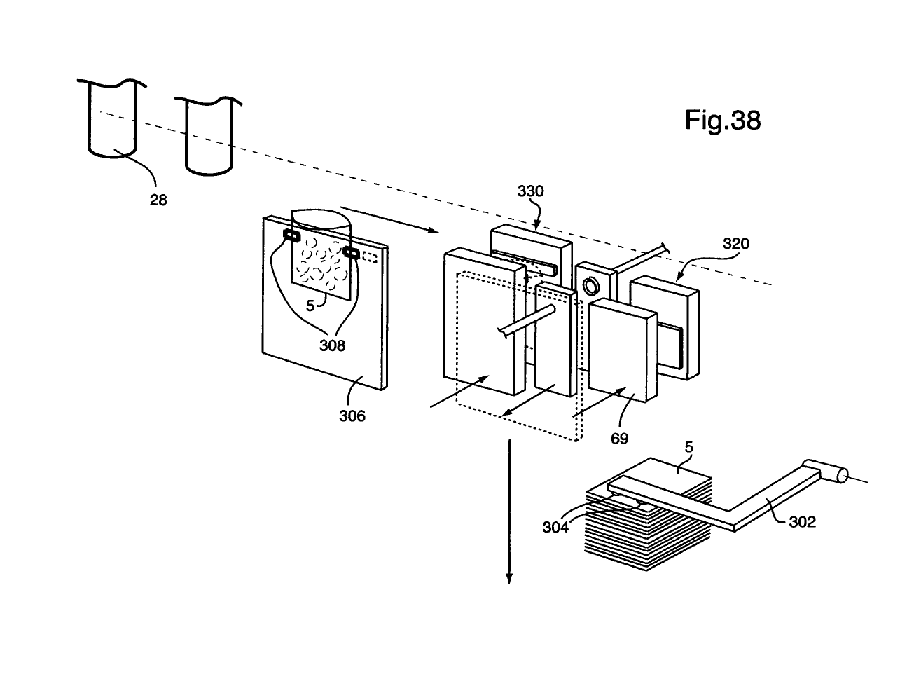

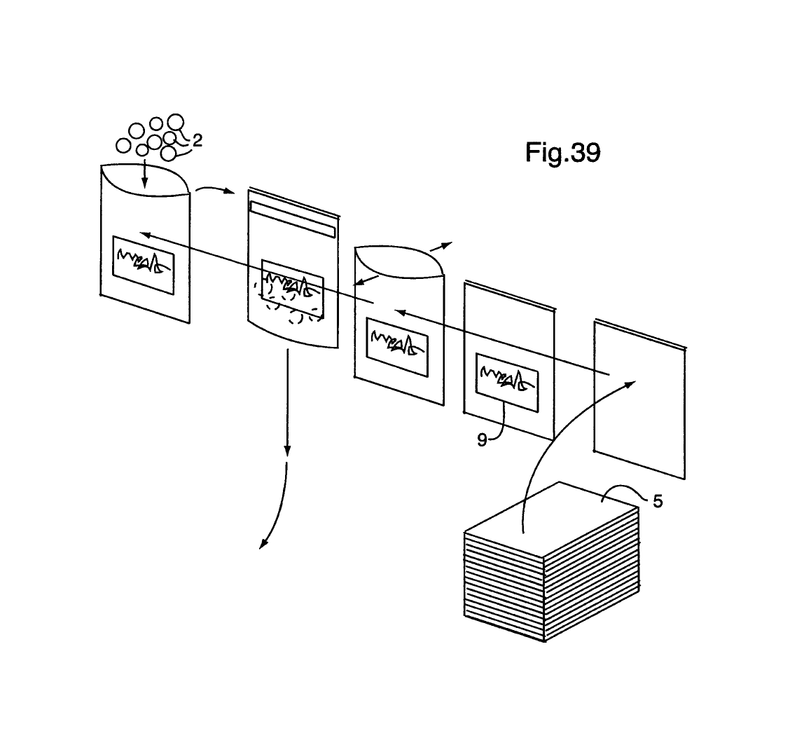

FIGS. 37 and 38 illustrate a further embodiment of a bagging system 300 for the vending machine (also shown in FIG. 2). An arm 302 pivotally mounted to the housing moves between a lifting position abutting a stack of flexible plastic bags 5, shown in solid lines in FIG. 37, and a loading position loading a bag 5 to the face of the shuttle 306 (shown in phantom lines in the home and dispensing positions in FIG. 37, and shown in solid lines in an intermediate position between the printing and filling stages).

The arm 302 comprises a lifting portion 302a having releasable attachment elements 304, such as suction cups, for lifting the top bag 5 in the stack. The arm 302 pivots to the loading position, carrying a bag 5 and positioning the bag 5 in the loaded position against the face of the shuttle 306. Clamps 308 are closed to grip the sides of the bag 5 and maintain it in position during the printing, filling and sealing processes.

The shuttle 306 travels along a track, such as track 76 illustrated in FIG. 21, through the printing station 320 and bag sealing station 330 and beneath the dispensing chutes 28 of the bulk venders 20. The bag may otherwise be loaded, labelled, opened, filled, sealed and dispensed in the manner described above in connection with the bagging system of FIG. 20.

One embodiment of a depletion detection system is shown in FIG. 3. In this embodiment the depletion detection system comprises LEDs 150 disposed in the wall of the product bin 22 across from optical receivers 152 tuned to the specific frequency of the LEDs 150. As items 2 are dispensed and the level of bulk product is reduced, light received by a receiver 152 from the associated LED 150 disposed on the opposite side of the bin 22 signals the processor, indicating the current product level in that product bin 22. The processor may communicate periodically, at preset intervals or following predetermined events, with a remote data processing device, for example a PC, located in the vending machine operator's premises to thus provide a depletion status of the various bulk vender modules 20 in the vending machine 10.

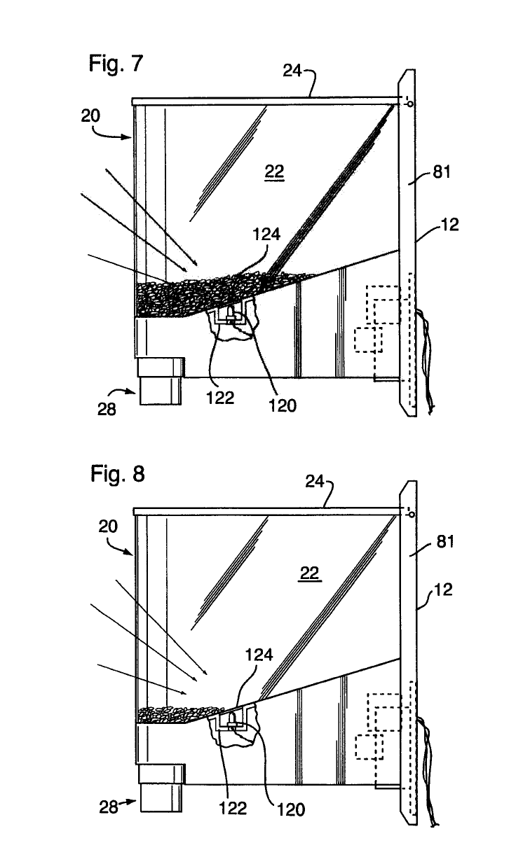

A further embodiment of a depletion detection system is shown in FIGS. 7 and 8. In this embodiment the depletion detection system comprises an optical receiver 120 sensitive to ambient light, disposed beneath a small window 124 in the floor 21 of the product bin 22. As items 2 are dispensed and the level of bulk product is reduced, light received by the receiver 120 signals the processor, indicating the current product level in that product bin 22. In this case also the processor may communicate periodically, at preset intervals or following predetermined events, with a remote data processing device, for example a PC, located in the vending machine operator's premises to thus provide a depletion status of the various bulk vender modules 20 in the vending machine 10.

In one embodiment the depletion detection system comprising LEDs 150 and optical receivers 152 shown in FIG. 3 can be combined with the depletion detection system comprising an optical receiver 120 sensitive to ambient light shown in FIGS. 7 and 8. In this embodiment the LEDs 150 and optical receivers 152 can signal the level of depletion of items in the product bin 22, while the optical receiver 120 can signal the controller to disable the particular vending module 20. If a user selects a disabled vending module 20, the video monitor 61 will display a “bin empty” or “bin out of order” message prompting the user to select another bin number or to enter a code for a credit or refund, depending on the method of payment.

FIG. 15 illustrates an embodiment of a bulk vender module 240 having a rotary turntable-type dispensing wheel. A product bin 242, for example composed of clear plastic, is supported by a base shroud 244 which conceals the drive assembly. Preferably the top of the base 244 (and thus the floor of the product bin 248) is inclined at an angle of approximately 20° toward the front of the vendor unit 240. Disposed near the front of the product bin 242, which is the low portion of the bin floor, is a dispensing wheel 270 seated in a hopper portion 246 of the shroud 244 and covered by a brush housing 272. As is known, the dispensing wheel 270 comprises product compartments 270a which are shielded when under the brush housing 272, and as the dispensing wheel 270 is rotated (by rotation of the actuator, for example a motor 50) an empty product compartment 270a rotates out from under the brush housing 272 to a position in communication with product stored in the product bin 242. At the same time a product compartment 270a initially in communication with product stored in the product bin 242 rotates under the brush housing 272 and comes into alignment with a dispensing opening (not shown) in the floor of the hopper portion 246, which in turn is aligned with the dispensing tube 264 or 266 to dispense product into the dispensing chute 260. A similar rotary dispensing wheel arrangement is described and illustrated in U.S. Pat. No. 4,534,492 to Schwarzli, which is incorporated herein by reference.

In the embodiment illustrated in FIG. 15 a primary agitator 274 is fixed to a shaft 276 engaged between the brush housing 272 and the lid (not shown) of the vendor module 240. In the embodiment shown the primary agitator 274 comprises a disk 274a having a resilient member, for example a coil spring 274b, extending from the disk 274a and rotating as the dispensing wheel 270 is rotated, to agitate product within the product bin 242 and avoid clumping or build-up of product around the periphery of the dispensing wheel 270. The primary agitator 274 may be composed of any suitable material, for example zinc or another non-corrosive metal, or from plastic, as desired. The lid 280 is preferably hinged to bracket (not shown) affixed to the back wall 12 of the vending machine 10, and provides a seat (not shown) I which the top end of the shaft 276 rotates when the bulk vendor unit 240 is in operation.

A secondary agitator 278 is disposed along the floor 248 of the product bin 242, toward the rear of the product bin. The secondary agitator 278 shown has a low profile, comprising blades 278a extending generally radially from a hub 278b, and serves to ensure that product resting on the floor 248 of the product bin 242 is agitated as the dispensing wheel 270 is rotated, and as such moves down the inclined floor 248 of the product bin 242 toward the dispensing wheel 270 each time product is purchased rather than stagnating in the upper portion of the inclined floor 248.

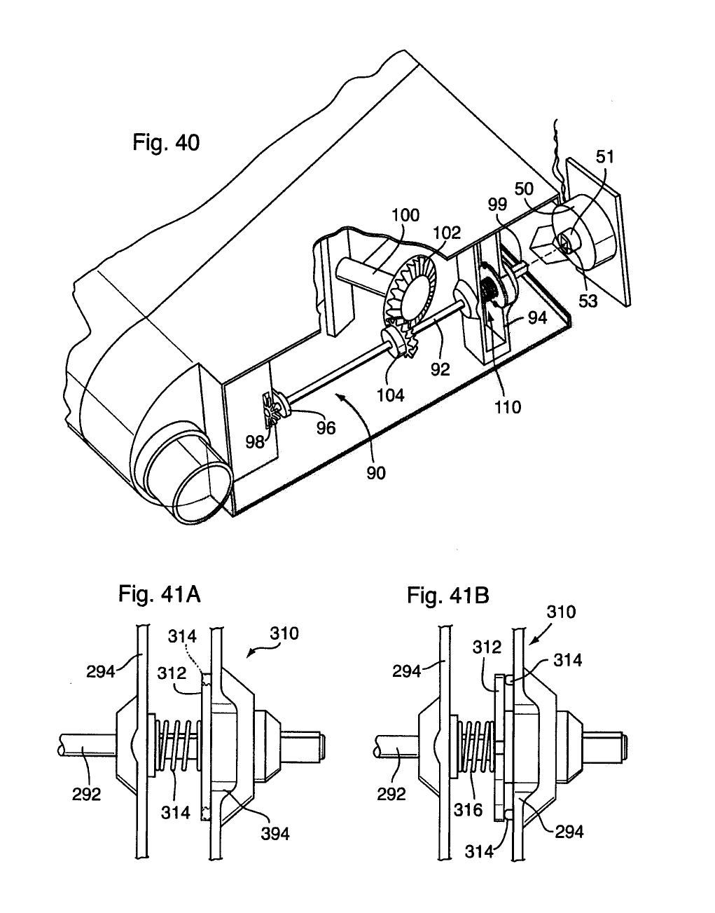

The dispensing wheel 270, primary agitator 274 and secondary agitator 278 are preferably (but not necessarily) driven by a common drive assembly 290 in the bulk vendor unit 240 shown, as illustrated in FIG. 40. A main drive shaft 292 is mounted through rear and front brackets 294, 296 and able to rotate therein. The front end of the drive shaft 290 is provided with a gear 298 which engages teeth (not shown) on the dispensing wheel 270, for example as described in U.S. Pat. No. 4,534,492 to Schwarzli. The primary agitator shaft 276 is rotationally fixed to the dispensing wheel 270, and thus rotates as the dispensing wheel 270 rotates. The hub 278b of the secondary agitator 278 is rotationally fixed to a secondary agitator shaft 300 which terminates within the shroud 244 in a bevel gear 302. A complementary bevel gear 304 attached to the drive shaft 292 at an intermediate portion between the brackets 294, 296 is engaged to the secondary agitator bevel gear 302, and thus rotates the secondary agitator 278 as the drive shaft rotates 292. The rear end of the drive shaft 292 is keyed to the actuator, which in the embodiment shown in electric motor 50 activated by the processor when the user selects the particular bulk vendor unit 240 operated by that respective motor 50, for example by a squared end 299 engaging a complementary square recess 253 formed in a hub 251 driven by the motor 50.

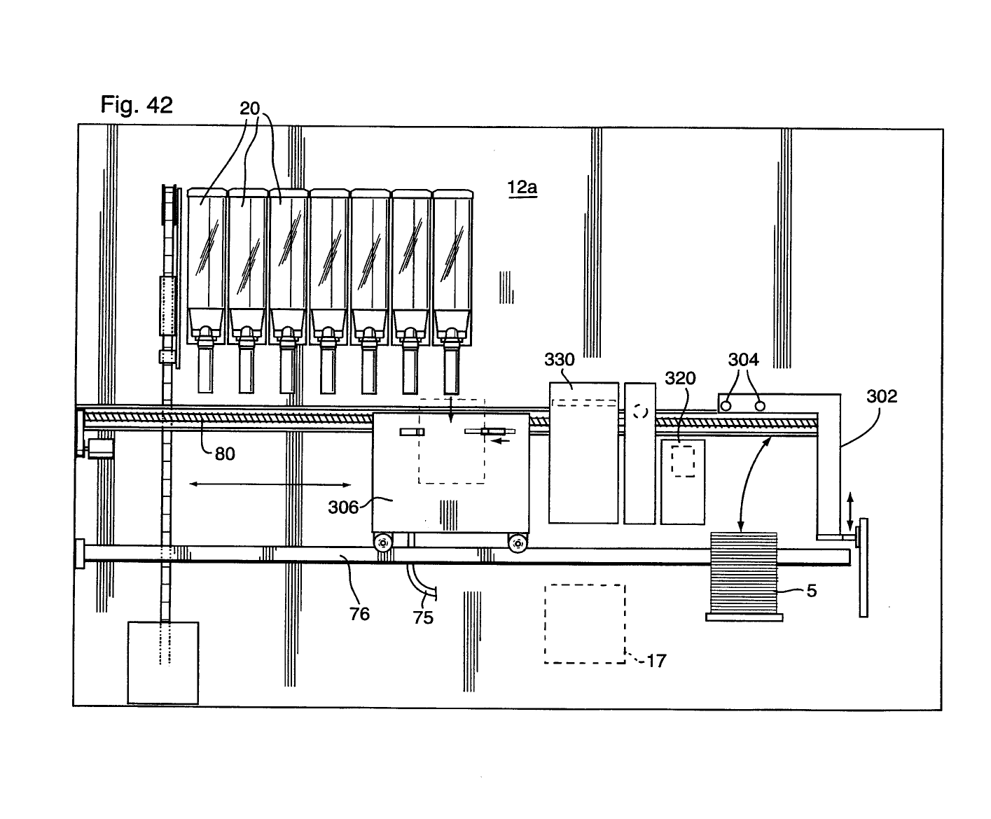

Optionally the rear end of the drive shaft 292 is provided with a clutch mechanism 310 which locks the drive shaft 292 in specific positions, for example at 90° intervals, when the bulk vendor unit 240 is pulled forward to the servicing position shown in FIG. 5. The clutch mechanism 310, illustrated in FIGS. 41A and 41B, is accommodated within the rear bracket 294. As the bulk vendor unit 240 is pulled away from the back 12 of the vending machine 10, a clutch disk 312 engages projections 314 extending forwardly from the bracket 294 when the drive shaft 292 is in one of the rotational positions in which the projections 314 lock into the clutch disk 312, which correspond to the start/end of each vending cycle. This ensures that when the bulk vending unit 240 is pushed back to the operating position shown in FIG. 4, the squared rear end 299 of the drive shaft 292 has not changed position and thus remains properly aligned with the square recess 253 in the drive hub 51 of the electric motor 50. When the bulk vendor unit 240 is pushed back into the operating position shown in FIG. 4 the clutch spring 316 is depressed, disengaging to the clutch wheel 312 from the projections 314 and allowing the drive shaft 292 to freely rotate under the influence of the electric motor 50. As illustrated in FIG. 5, pivoting the lid off of the product bin allows the bulk vendor unit 240 to be pulled to the servicing position, thus engaging the clutch 310 as described above.

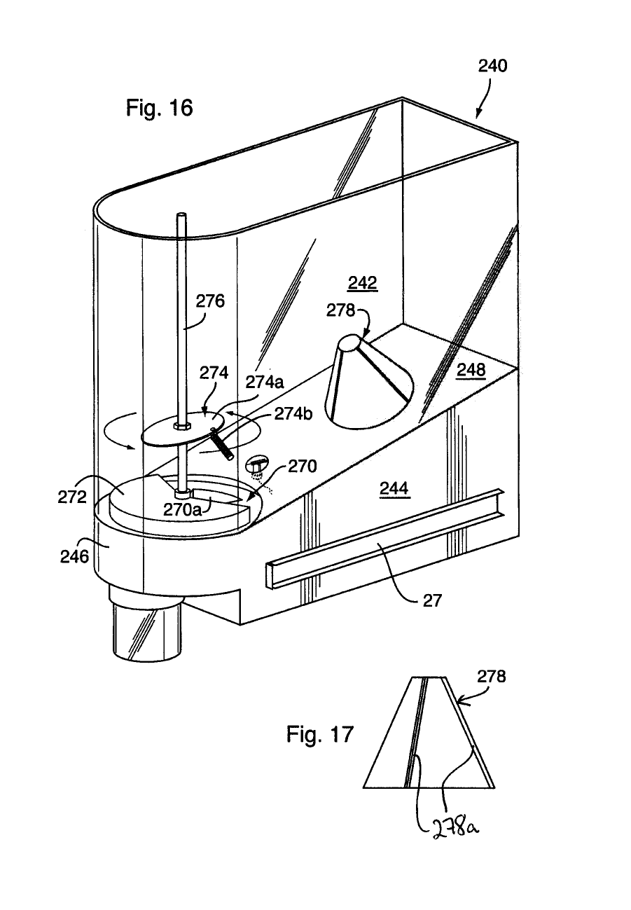

FIG. 16 illustrates an alternate embodiment of the vender module of FIG. 15 in which the secondary agitator comprises a cone-shaped agitator cap 278, shown in FIG. 17. In this embodiment the secondary agitator rotates in the same fashion as in the embodiment of FIG. 15. The agitator cap 278 may be provided with ribs 278a as shown, to engage items in the product bin or, depending upon the size and shape of the product being vended, may be provided with resilient members such as coil springs or silicon tubes (not shown) to provide better engagement with items in the product bin 42.

In the preferred embodiment, a compartment extending partly or completely down the front of the product bin 42 and isolated from product in the remainder of the product bin 42 by a divider 43 is filled with product, which makes the product bin 42 look full from the front of the vending machine 10 (and thus more appealing to users) and identifies the specific product contained in that specific bulk vendor unit 40.

The vending machine 10 may comprise bulk venders 20 as shown, or other types of vendors and any combination thereof. For example, one or more vender modules may comprise the ribbon vender 18 described and illustrated in PCT Patent Application Serial No. PCT/CA2008/001486, which is incorporated herein by reference, with the packaged product stored beneath the vender module for dispensing as shown in FIG. 42 and described in PCT Patent Application Serial No. PCT/CA2008/001486.

In some embodiments the display 61 may provide an “attract” mode to attract purchasers to the vending machine 10. The processor may be provided with software for playing a video game via the display 61, with suitable interfaces for the purchaser such as a joystick, motion sensors or the like.

Various embodiments of the present invention having been thus described in detail by way of example, it will be apparent to those skilled in the art that variations and modifications may be made without departing from the invention.

What is claimed is:

1. A vending machine, comprising,
a secure housing,
a plurality of vender modules contained within the housing, each vender module for dispensing a predetermined amount of merchandise into a container,
a control panel for entering a user selection of product from at least one selected vender module of the vender modules,
a processor for
receiving the user selection,
loading a container onto a shuttle,
driving the shuttle into dispensing communication with each selected vender module, and
driving each selected vender module through at least one dispensing cycle to dispense the user selection of product,
a sealing mechanism for sealing the container, and
a dispensing mechanism for dispensing the container to a user-accessible portion of the vending machine.

2. The vending machine of claim 1 comprising a printer for printing information or indicia, or both, on the container.

3. The vending machine of claim 2 wherein the printer prints directly onto the container.

4. The vending machine of claim 2 wherein the printer prints onto a label applied to the container before or after printing.

5. The vending machine of claim 1 wherein the vender modules each comprise a product bin comprising a floor having an inclined portion, comprising an agitator disposed at an intermediate point along the inclined portion of the floor.

6. The vending machine of claim 1 wherein the vender modules each comprise a product bin comprising a floor and at least one optical sensor disposed at a position above the floor, the sensor being activated when product in the product bin is depleted to a level below the sensor.

7. The vending machine of claim 1 wherein the vender modules each comprise a product bin comprising a floor having an inclined portion and at least one optical sensor disposed beneath the inclined portion of floor, the sensor being activated when product in the product bin is depleted to a level below the sensor.

8. The vending machine of claim 1 wherein each vender module comprises a dispensing drum having a dispensing slot for conveying product out of the vender module, a tubular resilient deflectable member disposed above and close to the drum, a light source disposed at one end of the deflectable member for directing light into the deflectable member, and a light receiver disposed at the other end of the deflectable member, whereby when product protruding from the dispensing slot deflects the deflectable member prevents light from striking the receiver a direction of the dispensing drum is momentarily reversed.

9. The vending machine of claim 1 wherein each vender module is provided with a chute for directing dispensed merchandise into the container, the chute reciprocating with the dispensing mechanism between a position clear of the container and a position below an opening of the container.

10. The vending machine of claim 9 wherein the chute provides a resilient damper to slow the descent of product through the chute.

11. The vending machine of claim 1 wherein the container is a bag.

12. A method of dispensing merchandise from a vending machine comprising a secure housing containing a plurality of vender modules each for dispensing a predetermined amount of merchandise into a container, comprising the steps of:
a. in any order,
i. receiving a user selection of product from at least one selected vender module of the vender modules, and
ii. loading a container onto a shuttle,
b. driving the shuttle into dispensing communication with at least one selected vender module,
c. driving the selected vender module through at least one dispensing cycle to dispense the user selection of product into the container,
d. repeating steps b. and c. for each selected vender,
e. sealing the container, and
f. dispensing the container to a user-accessible portion of the vending machine.

13. The method of claim 12 comprising, at any time after step a(i), the step of printing information or indicia, or both, on the container.

14. The method of claim 13 wherein the step of printing comprises printing directly onto the container.

15. The method of claim 13 wherein the step of printing comprises printing directly onto the container onto a label applied to the container before or after printing.

16. A vending machine, comprising,
a secure housing,
at least one vender module contained within the housing, for dispensing a predetermined amount of merchandise into a container,
a dispensing mechanism for dispensing the container to a user-accessible portion of the vending machine, and
a printer for printing information or indicia, or both, on the container prior to dispensing the container.

17. The vending machine of claim 16 wherein the printer prints directly onto the container.

18. The vending machine of claim 16 wherein the printer prints onto a label applied to the container before or after printing.

19. The vending machine of claim 16 comprising a plurality of vender modules, each vender module for dispensing a predetermined amount of merchandise into the container.

20. The vending machine of claim 19 comprising a control panel for entering a user selection of product from at least one selected vender module of the vender modules, a processor for receiving the user selection, loading a container onto a shuttle, driving the shuttle into dispensing communication with each selected vender module and driving each selected vender module through at least one dispensing cycle to dispense the user selection of product, and a sealing mechanism for sealing the container.
